(19) United States
(12) Patent Application Publication
(10) Pub. No.: US 2012/0026123 A1
(43) Pub. Date: Feb. 2, 2012

(54) Compensation for Capacitance Change in Touch Sensing Device

(76) Inventors: Martin Paul GRUNTHANER, Mountain View, CA (US); Jonah A. Harley, Mountain View, CA (US); Christopher Tenzin Mullens, San Francisco, CA (US)

(21) Appl. No.: 12/848,032

(22) Filed: Jul. 30, 2010

(51) Int. Cl. G06F 3/045

(52) U.S. Cl. 345/174

(57) ABSTRACT

This relates to compensation for undesirable capacitance changes in a touch sensing device, where the capacitance changes are not indicative of a touch at the device. The touch sensing device can include a touch sensor panel having touch sensors for sensing a touch at the panel, a flexible circuit for transmitting the sensed touch signal from the panel, and a touch controller for receiving and processing the transmitted signal. To compensate for the capacitance changes, the touch sensing device can include one or more reference conductive traces decoupled from touch sensors of the device to measure non-touch capacitances in the device. The touch sensing device can then adjust a touch signal from the touch sensors using the non-touch capacitance measurements to substantially reduce or eliminate the non-touch capacitances from the signal.

### FIELD

This relates generally to touch sensing devices and, more particularly, to compensation for undesirable capacitance changes in a touch sensing device.

### BACKGROUND

Touch sensitive devices have become quite popular as input devices to computing systems because of their ease and versatility of operation as well as their declining price. A touch sensitive device can include a touch sensor panel, which can be a clear panel with a touch sensitive surface, and a display device such as a liquid crystal display (LCD) that can be positioned partially or fully behind the panel so that the touch sensitive surface can cover at least a portion of the viewable area of the display device. The touch sensitive device can allow a user to perform various functions by touching the touch sensor panel using a finger, stylus or other object at a location often dictated by a user interface (UI) being displayed by the display device. In general, the touch sensitive device can recognize a touch event and the position of the touch event on the touch sensor panel, and the computing system can then interpret the touch event in accordance with the display appearing at the time of the touch event, and thereafter can perform one or more actions based on the touch event.

At times, environmental conditions and device operations can adversely affect the touch sensitive device's ability to recognize a touch event. For example, capacitance changes due to a change in the device temperature caused by either an ambient temperature change or heat from device components can mask a real touch event or erroneously indicate a false touch event. Because a touch sensitive device cannot avoid generating some heat during operation and cannot control the outside environment, it can be difficult to prevent errors in touch event recognition.

### SUMMARY

This relates to compensation for undesirable capacitance changes in a touch sensing device. The capacitance changes, which can be caused by environmental changes and/or device operating changes and not by a touch, can mask an actual touch at the device and/or erroneously indicate a false touch. To compensate for such capacitance changes, the touch sensing device can include one or more reference conductive traces decoupled from touch sensors of the device to measure non-touch capacitance. The touch sensing device can then adjust a touch signal with the non-touch capacitance measurement to substantially reduce or eliminate the non-touch capacitance from the signal. In one example, the reference trace can be disposed on a flexible circuit of the touch sensing device parallel to a conductive trace that transmits the touch signal from a touch sensor panel of the device, thereby giving an indication of the non-touch capacitance introduced by the conductive trace. In another example, the reference trace can be extended onto the touch sensor panel parallel to a touch sensor trace that transmits the touch signal from a touch sensor to the conductive trace on the flexible circuit, thereby giving an indication of the non-touch capacitances introduced by the touch sensor trace and the conductive trace. In still another example, the reference trace can be extended further onto the touch sensor panel to couple to a conductive element on the panel that measures non-touch capacitance of the touch sensor, thereby giving an indication of the non-touch capacitances introduced by the touch sensor, the touch sensor trace, and the conductive trace. In another example, the reference trace coupled to a touch controller of the touch sensing device (to which the reference trace transmits the non-touch capacitances of the touch sensor, the touch sensor trace, and/or the conductive trace) can give an indication of the non-touch capacitance introduced by various components on the touch controller. Compensation for undesirable capacitance changes in the touch sensing device can advantageously provide a more accurate and reliable touch signal regardless of the conditions and circumstances in which the device operates.

### BRIEF DESCRIPTION OF THE DRAWINGS

FIG. 1 illustrates an exemplary touch sensing device that can compensate for capacitance changes according to various embodiments.

FIG. 2 illustrates another exemplary touch sensing device that can compensate for capacitance changes according to various embodiments.

FIG. 3 illustrates another exemplary touch sensing device that can compensate for capacitance changes according to various embodiments.

FIG. 4 illustrates another exemplary touch sensing device that can compensate for capacitance changes according to various embodiments.

FIG. 5 illustrates an exemplary method to compensate for capacitance changes in a touch sensing device according to various embodiments.

FIG. 6 illustrates an exemplary computing system that can compensate for capacitance changes according to various embodiments.

FIG. 7 illustrates an exemplary mobile telephone that can compensate for capacitance changes according to various embodiments.

FIG. 8 illustrates an exemplary digital media player that can compensate for capacitance changes according to various embodiments.

FIG. 9 illustrates an exemplary personal computer that can compensate for capacitance changes according to various embodiments.

### DETAILED DESCRIPTION

In the following description of various embodiments, reference is made to the accompanying drawings which form a part hereof, and in which it is shown by way of illustration specific embodiments which can be practiced. It is to be understood that other embodiments can be used and structural changes can be made without departing from the scope of the various embodiments.

This relates to compensation for undesirable capacitance changes in a touch sensing device, where the capacitance changes are not indicative of a touch at the device, but of environmental changes or device operating changes. Environmental changes can include ambient temperature, humidity, and barometric pressure changes. Device operating changes can include start-up, shutdown, and prolonged operation of device components. To compensate for such capacitance changes, the touch sensing device can include one or more reference conductive traces decoupled from touch sensors of the device to measure non-touch capacitances in the device. The touch sensing device can then adjust a touch signal from the touch sensors using the non-touch capacitance measurements to substantially reduce or eliminate the non-touch capacitances from the signal.

The touch sensing device can include a touch sensor panel having one or more touch sensors for sensing a touch at the panel, a flexible circuit for transmitting the sensed touch signal from the panel, and a touch controller for receiving and processing the transmitted signal. In one embodiment, the reference trace can be disposed on the flexible circuit parallel to a conductive trace that transmits the touch signal from the touch sensor panel to the touch controller, thereby giving an indication of the non-touch capacitance introduced by the conductive trace. One end of the reference trace can be coupled to the touch controller to transmit the non-touch capacitance thereto. The other end of the reference trace can be free on the flexible circuit.

In another embodiment, the reference trace can be extended onto the touch sensor panel parallel to a touch sensor trace that transmits the touch signal from a touch sensor to the conductive trace on the flexible circuit, thereby giving an indication of the non-touch capacitances introduced by the touch sensor trace and the conductive trace. One end of the reference trace can be coupled to the touch controller to transmit the non-touch capacitances thereto. The other end of the reference trace can be free on the touch sensor panel.

In still another embodiment, the reference trace can be extended further onto the touch sensor panel to couple to a conductive element on the panel that measures non-touch capacitance of the touch sensor, thereby giving an indication of the non-touch capacitances introduced by the touch sensor, the touch sensor trace, and the conductive trace. One end of the reference trace can be coupled to the touch controller to transmit the non-touch capacitances thereto. The other end of the reference trace can be coupled to the conductive element on the panel.

In another embodiment, the reference trace coupled to the touch controller can give an indication of the non-touch capacitance introduced by various components on the touch controller along with non-touch capacitances of the conductive trace, the touch sensor trace, and/or the touch sensor.

Compensating for undesirable capacitance changes can advantageously realize more accurate and reliable touch measurements regardless of the conditions and circumstances in which the touch sensing device operates.

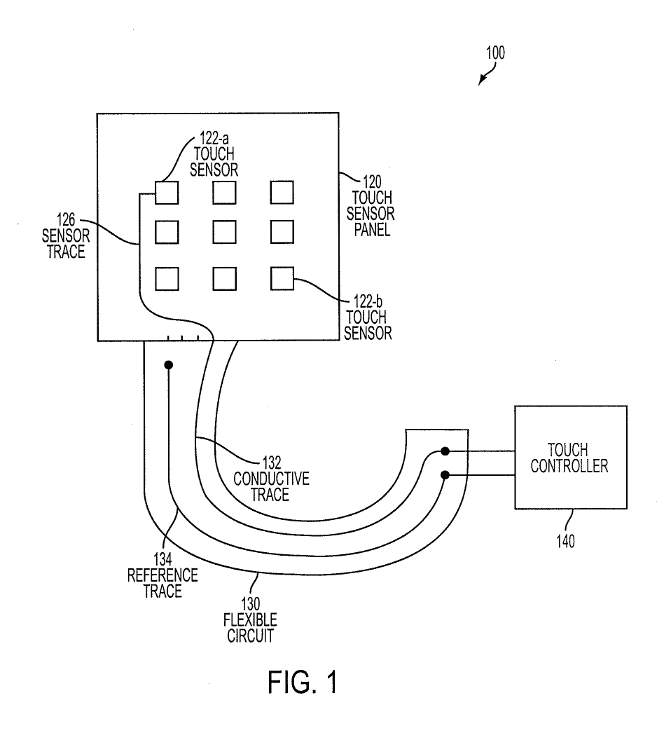

FIG. 1 illustrates an exemplary touch sensing device that can compensate for undesirable capacitance changes according to various embodiments. In the example of FIG. 1, touch sensing device 100 can include touch sensor panel 120, flexible circuit 130, and touch controller 140 to sense a touch or near-touch (hover) at the device. As an object approaches the panel 120, a small capacitance can form between the object and capacitive touch sensors 122 proximate to the object. Touch signals indicating changes in capacitance caused by this small capacitance and the position of the touch sensor 122-a sensing the object can be transmitted along sensor trace 126 through the flexible circuit 130 to the touch controller 140 for processing. The capacitive touch sensors 122 can be based on self capacitance.

In a self capacitance sensor panel, the self capacitance of a touch sensor can be measured relative to some reference, e.g., ground. The touch sensors 122 can be spatially separated electrodes. The touch sensors 122 can be indium-tin-oxide (ITO) or any suitable conductive material. Each electrode can define a touch sensor 122. The electrodes can be coupled to driving circuitry via conductive traces (not shown) and to sensing circuitry, e.g., the touch controller 140, via sensor traces 126. The sensor traces 126 can be silver, copper, or any suitable conductive material. Each touch sensor electrode 122 can have a sensor trace 126. Touches, near-touches (hovers), and gestures can be detected at the panel 120 by measuring changes in the capacitance of the electrode forming the touch sensor 122.

During operation, the total capacitance along a sensing path can be measured from the touch sensors 122 to the touch controller 140. Under normal conditions, in some embodiments, the capacitance of the touch sensors 122 can be approximately 12 picofarads (pF), the sensor traces 126 approximately 2 pF, the conductive traces 132 approximately 8-10 pF, and various components at the touch controller 140 about 2 pF. In some embodiments, a touch at the touch sensors 122 can increase the total capacitance by 0.3 to 1.5 pF. Upon measuring this increase, the touch controller 140 can deduce that there has been a touch at the panel 120 and perform further processing accordingly.

However, when the device experiences environmental changes or device operating changes that cause the device temperature, for example, to increase, the dielectric constants and/or the geometry of the device materials can change, thereby increasing the capacitances of proximate conductive components. In some instances, the capacitance change due to environmental changes or device operating changes can exceed the capacitance change due to a touch. Some materials can be more sensitive to environmental or device changes than others and therefore more prone to change their dielectric constants. For example, the touch sensor panel substrate can be glass or like substrates, which can be less sensitive to changes; whereas the flexible circuit substrate can be polyimide or like flexible polymers, which can be more sensitive to changes. In some instances, the flexible circuit's conductive components can contribute a majority of the increase in capacitance when there are environmental or device operating changes. Therefore, eliminating or reducing the contributions from at least the flexible circuit's components can substantially reduce or eliminate the effects of the changes.

To do so, referring again to FIG. 1, reference trace 134 can be disposed on the flexible circuit 130 parallel to the conductive trace 132, but decoupled from the touch sensor 122-a. As such, the reference trace 134 can provide the same or a similar capacitance as the conductive trace 132. When there is an environmental or device operating change that causes a temperature increase, for example, in the flexible circuit 130, the capacitance of the reference trace 134 and the conductive trace 132 can increase or otherwise change in a similar manner. The amount of the increase may not be readily apparent on the conductive trace 132 because the trace may also include a touch signal. However, since the reference trace 134 is decoupled from the touch sensor 122-a, the reference trace can have just the capacitance measurement. Therefore, the amount of the capacitance increase can be measured from the reference trace 134 and applied to the transmitted touch signal to substantially reduce or eliminate the conductive trace's capacitance increase from the signal. This can provide a more accurate touch measurement despite the undesirable capacitance change.

Similarly, a hover measurement can be adjusted by applying the capacitance measurement from the reference trace 134 to the transmitted hover signal to substantially reduce or eliminate the conductive trace's capacitance increase from the signal. A touch and hover measurement can be similarly adjusted to substantially reduce or eliminate the conductive trace's capacitance increase from the transmitted touch and hover signal.

In alternate embodiments, one or more additional reference traces can be disposed on the flexible circuit parallel to the conductive trace, but decoupled from the touch sensors. Capacitances can vary somewhat by location on the flexible circuit according to the number of neighboring traces, which can parasitically couple with a trace. As such, a reference trace can be placed in the middle of the flexible circuit, while another reference trace can be placed at an edge of the flexible circuit. The appropriate edge and/or center reference trace can then be used to correspondingly compensate neighboring conductive traces that are either edge or center races. Alternatively, an average capacitance from the reference traces can be calculated and applied to the touch measurement to compensate for the undesirable capacitance changes. Or the capacitance(s) of the reference trace(s) closest to the conductive trace can be applied to the touch measurement.

It is to be understood that the touch sensor arrangement is not limited to that illustrated herein, but can be a radial, circular, diamond, diagonal, and like arrangements according to the needs of the device.

It is to be further understood that the touch sensing device is not limited to self capacitance, but can be based on mutual capacitance as well. In a mutual capacitance sensor panel, the mutual capacitance of a touch sensor can be measured between two conductors. The touch sensors can be formed by the crossing of patterned conductors forming spatially separated drive and sense lines, or by placing the drive and sense lines adjacent to each other. Driving circuitry can be coupled to the drive lines and sensing circuitry can be coupled to the sensing lines. Touches, near-touches (hovers), and gestures can be detected at the panel by measuring changes in the capacitance between the drive and sense lines associated with the touch sensor.

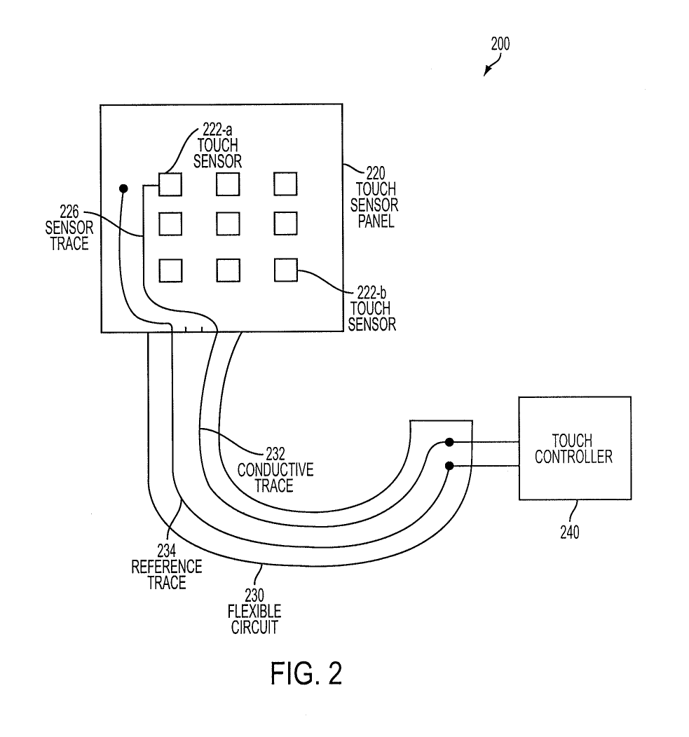

FIG. 2 illustrates another exemplary touch sensing device that can compensate for undesirable capacitance changes according to various embodiments. The device of FIG. 2 is the same as the device of FIG. 1 except for the following addition. In the example of FIG. 2, reference trace 234 can extend onto touch sensor panel 220 to be proximate to sensor trace 226. As a result, the reference trace 234 can have a same or similar capacitance as the sensor trace 226 in addition to having a same or similar capacitance as the conductive trace 232. While the flexible circuit 230 can contribute to an undesirable capacitance change, the touch sensor panel 220 can also contribute, such that eliminating or substantially reducing the effects of the panel can likewise be helpful. When there is an environmental or device operating change that causes a temperature increase, for example, in touch sensor panel 120, the capacitance of the reference trace 134 and the sensor trace 126 can increase. The amount of the increase may not be readily apparent on the sensor trace 226 because the trace may also include a touch signal. However, since the reference trace 234 is decoupled from the touch sensor 222-a, the reference trace can just have the capacitance measurement. The amount of the increase can therefore be measured from the reference trace 234 and applied to the transmitted touch signal to substantially reduce or eliminate the sensor trace's capacitance increase from the signal. As described in FIG. 1, the amount of the increase in the conductive trace's 232 capacitance can also be measured from the reference trace 234 and applied to the transmitted touch signal to substantially reduce or eliminate the conductive trace's capacitance increase from the signal. Application of the reference trace capacitance measurement can provide a more accurate touch measurement despite the undesirable capacitance changes.

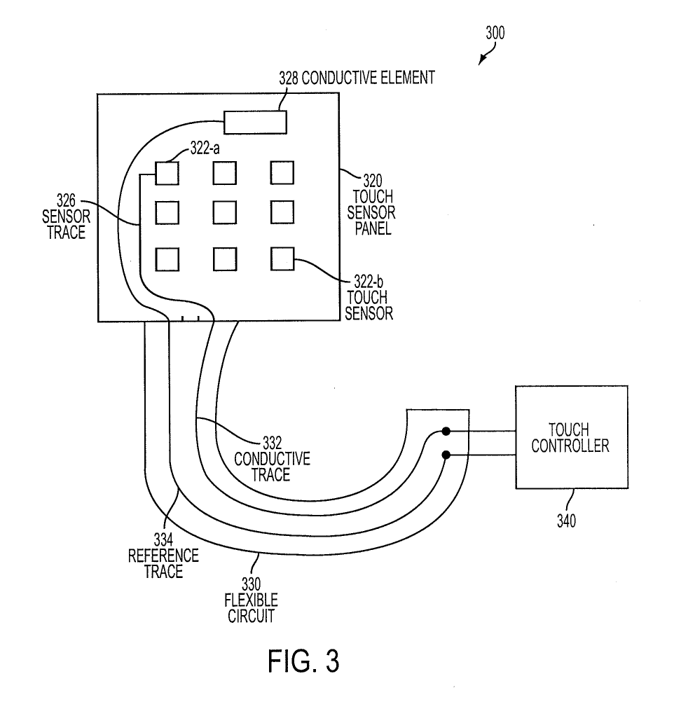

FIG. 3 illustrates another exemplary touch sensing device that can compensate for capacitance changes according to various embodiments. The device of FIG. 3 is the same as the device of FIG. 2 except for the following addition. In the example of FIG. 3, reference trace 334 can extend further onto touch sensor panel 320 to be coupled to conductive element 328. The conductive element 328 can be ITO similar to the touch sensors 322. As a result, the conductive element 328 can have a same or similar capacitance as the touch sensors 322. When there is an environmental or device operating change that cause a temperature increase, for example, in the touch sensor panel 320, the capacitance of the conductive element 328 and the touch sensors 322 can increase or otherwise change in a similar manner. The amount of the increase may not be readily apparent on the touch sensors 322 because the sensors may also include a touch signal. However, since the conductive element 328 is not coupled to the touch sensor 322-a, the conductive element can have just the capacitance measurement associated with an environmental or device operating change. The amount of the increase can therefore be measured from the conductive element 328 and therefore the reference trace 324 and applied to the transmitted touch signal to substantially reduce or eliminate the touch sensors' non-touch capacitance increase from the signal. As described in FIG. 2, the amount of increase in the sensor trace's 326 and the conductive trace's 332 capacitances can also be measured from the reference trace 324 and applied to the transmitted touch signal to substantially reduce or eliminate the sensor trace's and the conductive trace's capacitance increases from the signal. Application of the reference trace capacitance measurement can provide a more accurate touch measurement despite the undesirable capacitance changes.

In an alternate embodiment, the reference trace can couple to the conductive element without following the sensor trace such that the reference trace can provide capacitance increases of the touch sensor on the touch sensor panel and the conductive traces on the flexible circuit. This embodiment may be useful when the sensor traces' capacitance increases are not very significant, when space is limited on the panel, or for any suitable reason.

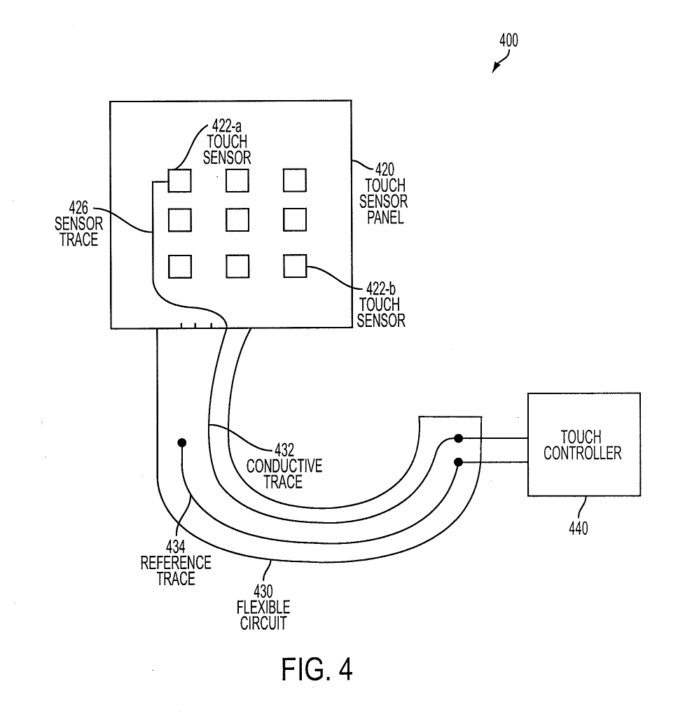

FIG. 4 illustrates another exemplary touch sensing device that can compensate for undesirable capacitance changes according to various embodiments. The device of FIG. 4 is the same as the device of FIG. 1 except for the following. In the example of FIG. 4, reference trace 434 can extend only part of the length of conductive trace 432. This arrangement can be useful when the flexible circuit 430 is space-limited. Similar to reference trace 134 of FIG. 1, the reference trace 434 of FIG. 4 can transmit a capacitance measurement indicative of a capacitance change in the conductive trace 432 caused by environmental or device operating changes affecting the flexible circuit 430. The amount of the increase can therefore be measured from the reference trace 434 and applied to the transmitted touch signal to substantially reduce or eliminate the conductive trace's 432 capacitance increase from the signal. The amount of capacitance applied to the transmitted touch signal can be scaled either proportionally or otherwise to more closely approximate the conductive trace's 432 capacitance with the reduced reference trace 434. Application of the reference trace capacitance measurement can provide a more accurate touch measurement despite the undesirable capacitance change.

As illustrated in FIGS. 1 through 4, the reference trace can be coupled to the touch controller to transmit capacitance measurements thereto. Various components of the touch controller can also introduce undesirable capacitance changes into the touch sensing device. Accordingly, the reference trace can measure capacitance changes of these components, which can be used along with the measurements associated with the conductive traces on the flexible circuit, the sensor traces on the touch sensor panel, and/or the conductive elements on the touch sensor panel to adjust touch measurements.

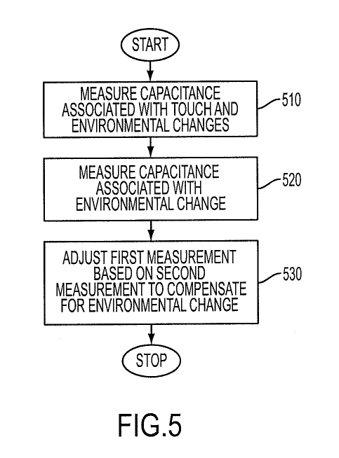

FIG. 5 illustrates an exemplary method to compensate for undesirable capacitance changes in a touch sensing device according to various embodiments. In the example of FIG. 5, a touch controller can measure a touch signal from a touch sensor that is transmitted to the controller through a conductive trace on a flexible circuit coupled to the touch sensor (510). The touch signal can include a first capacitance indicative of a touch at the touch sensor and a second capacitance indicative of an environmental or device operating change affecting the flexible circuit. The touch controller can measure the second capacitance from a reference trace on the flexible circuit parallel and proximate to the conductive trace, but decoupled from the touch sensor (520). The touch controller can then adjust the touch measurement based on the second capacitance measurement to compensate the touch measurement for the undesirable capacitance change (530). The result can be a more accurate touch measurement despite the capacitance change.

In alternate embodiments, the touch controller can measure the second capacitance from a reference trace on the touch sensor panel and the flexible circuit, where a portion of the reference trace is parallel and proximate to a sensor trace on the panel and another portion of the reference trace is parallel and proximate to a conductive trace on the flexible circuit (520).

In alternate embodiments, the touch controller can measure the second capacitance from a reference trace coupled to a conductive element on the touch sensor panel in addition to being parallel and proximate to the sensor trace on the panel and/or the conductive trace on the flexible circuit (520).

The method of FIG. 5 can be implemented according to various embodiments. In one embodiment, the method can account for a change in measured touch sensor capacitance by measuring the change in the reference trace on the flexible circuit and scaling the result accordingly.

This method can start with the assumption that the untouched sensor capacitance is made up of the flexible circuit substrate capacitance, C_{flex}, plus the touch sensor panel substrate capacitance, Cₚₐₙₑₗ, and that the flexible circuit capacitance is fully known from measurements of the reference trace on the flexible circuit.

Cₛₑₙₛₒᵣ=Cₚₐₙₑₗ+C_{flex}. (1)

In order to measure capacitance changes, baseline values can be known for the flexible circuit (the reference trace) and overall touch sensor (panel+flexible circuit). These values can be obtained anytime when the sensor is untouched, such as during a factory calibration. Considering the example of temperature compensation, suppose the calibration measurement was taken at temperature T1 and the current measurement is at temperature T2. As such, the change in capacitance for the flexible circuit can be

ΔC_{flex}=C_{flex}_{_{—}}_{T2}−C_{_{—}}_{flex}_{_{—}}_{T1} (2)

and for the sensor,

ΔCₛₑₙₛₒᵣ=Cₛₑₙₛₒᵣ_{_{—}}_{T2}−Cₛₑₙₛₒᵣ_{_{—}}_{T1}. (3)

Using Equations (1), (2), and (3), the change in capacitance for the panel substrate can be

ΔCₚₐₙₑₗ=Cₚₐₙₑₗ_{_{—}}_{T2}−Cₚₐₙₑₗ_{_{—}}_{T1}. (4)

The panel substrate capacitance can track the flexible circuit capacitance and can be scaled according to the ratio of the capacitances (i.e., the percent capacitance change can track) and can additionally have a scaling factor α if the temperature coefficients of the panel substrate and the flexible circuit are different. This can be expressed as

$$\frac{Δ {C}_{panel}}{{C}_{panel\_T 1}} = α \frac{Δ {C}_{flex}}{{C}_{flex\_T 1}} . \qquad ( 5 )$$

If the original values of C_{flex}_{_{—}}_{T1} and Cₛₑₙₛₒᵣ_{_{—}}_{T1} are known at temperature T1, and the change of the flexible circuit capacitance is known from the reference trace, then a sensor measurement at temperature T2 can be scaled back to the reference temperature T1, using the formula

Cₛₑₙₛₒᵣ_{_{—}}_{comp}=Cₛₑₙₛₒᵣ_{_{—}}_{T2}−ΔC_{flex}−ΔCₚₐₙₑₗ (6)

where ΔCₚₐₙₑₗ can be estimated from Equation (5) and the measured ΔC_{flex}. Substituting from Equation (5) into Equation (6), the compensated sensor measurement can be expressed as

$${C}_{sensor\_comp} = {C}_{sensor\_T 2} - Δ {C}_{flex} - α \frac{Δ {C}_{flex}}{{C}_{flex\_T 1}} {C}_{panel\_T 1} . \qquad ( 7 )$$

Here, the change in flexible circuit capacitance and the change in panel substrate capacitance can be subtracted from the sensor measurement to provide the compensated sensor measurement. The scaling factor α can typically vary from 0.5 to 2, but can span an even larger range if the panel substrate and the flexible circuit are vastly different in temperature sensitivity, one being more temperature sensitive than then other.

If the reference trace is shorter than the conductive traces, as shown in FIG. 4, the capacitance change can first be scaled by the length of the conductive trace 432 to the reference trace 434 prior to applying the above method.

An alternative method can simply assume that the overall sensor measurement tracks proportionally with the flexible circuit capacitance, according to

$${C}_{sensor\_comp} = \frac{{C}_{flex\_T 2}}{{C}_{flex\_T 1}} {C}_{sensor\_T 1} . \qquad ( 8 )$$

Here, it can be assumed that the panel substrate temperature coefficient matches the flexible circuit temperature coefficient and, therefore, has additional error taken into account.

Although these example methods address temperature compensation, they can apply equally well to other environmental changes, e.g., humidity and pressure, and to design operating changes.

It is to be understood that the method of FIG. 5 is not limited to these embodiments, but can include other methods suitable for compensating a touch measurement for environmental or device operating changes.

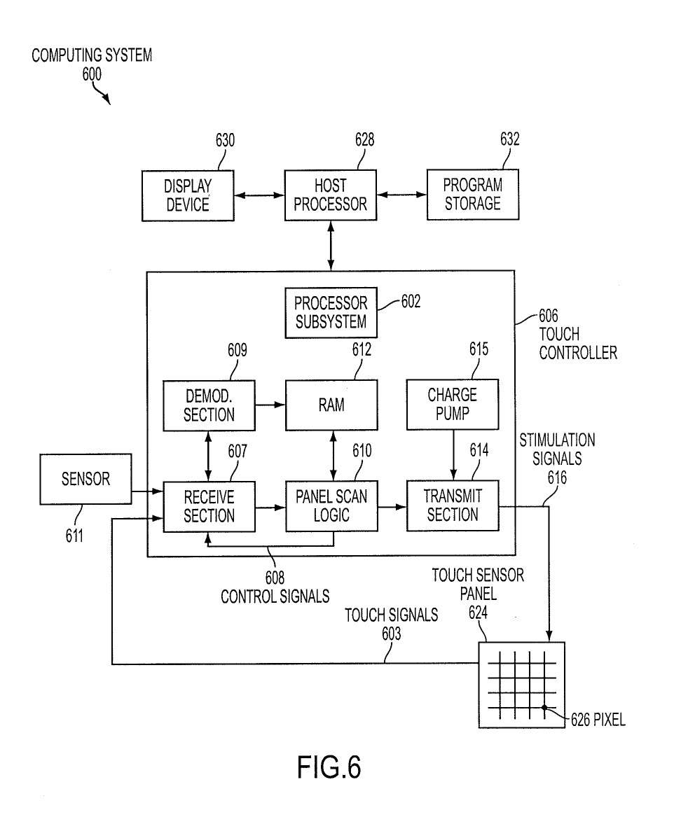

FIG. 6 illustrates an exemplary computing system 600 that can compensate for an undesirable capacitance change in a touch sensing device according to various embodiments described herein. In the example of FIG. 6, computing system 600 can include touch controller 606. The touch controller 606 can be a single application specific integrated circuit (ASIC) that can include one or more processor subsystems 602, which can include one or more main processors, such as ARM968 processors or other processors with similar functionality and capabilities. However, in other embodiments, the processor functionality can be implemented instead by dedicated logic, such as a state machine. The processor subsystems 602 can also include peripherals (not shown) such as random access memory (RAM) or other types of memory or storage, watchdog timers and the like. The touch controller 606 can also include receive section 607 for receiving signals, such as touch signals 603 of one or more sense channels (not shown), other signals from other sensors such as sensor 611, etc. The touch controller 606 can also include demodulation section 609 such as a multistage vector demodulation engine, panel scan logic 610, and transmit section 614 for transmitting stimulation signals 616 to touch sensor panel 624 to drive the panel. The panel scan logic 610 can access RAM 612, autonomously read data from the sense channels, and provide control for the sense channels. In addition, the panel scan logic 610 can control the transmit section 614 to generate the stimulation signals 616 at various frequencies and phases that can be selectively applied to rows of the touch sensor panel 624.

The touch controller 606 can also include charge pump 615, which can be used to generate the supply voltage for the transmit section 614. The stimulation signals 616 can have amplitudes higher than the maximum voltage by cascading two charge store devices, e.g., capacitors, together to form the charge pump 615. Therefore, the stimulus voltage can be higher (e.g., 6V) than the voltage level a single capacitor can handle (e.g., 3.6 V). Although FIG. 6 shows the charge pump 615 separate from the transmit section 614, the charge pump can be part of the transmit section.

Touch sensor panel 624 can include a capacitive sensing medium having electrodes for detecting a touch at the panel. The electrodes can be formed from a transparent conductive medium such as Indium Tin Oxide (ITO) or Antimony Tin Oxide (ATO), although other transparent and non-transparent materials such as copper can also be used. Each electrode can represent a capacitive sensing node and can be viewed as picture element (pixel) 626, which can be particularly useful when the touch sensor panel 624 is viewed as capturing an “image” of touch. (In other words, after the touch controller 606 has determined whether a touch event has been detected at each touch sensor in the touch sensor panel, the pattern of touch sensors in the panel at which a touch event occurred can be viewed as an “image” of touch (e.g. a pattern of fingers touching the panel).)

Computing system 600 can also include host processor 628 for receiving outputs from the processor subsystems 602 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. The host processor 628 can also perform additional functions that may not be related to panel processing, and can be coupled to program storage 632 and display device 630 such as an LCD display for providing a UI to a user of the device. In some embodiments, the host processor 628 can be a separate component from the touch controller 606, as shown. In other embodiments, the host processor 628 can be included as part of the touch controller 606. In still other embodiments, the functions of the host processor 628 can be performed by the processor subsystem 602 and/or distributed among other components of the touch controller 606. The display device 630 together with the touch sensor panel 624, when located partially or entirely under the touch sensor panel or when integrated with the touch sensor panel, can form a touch sensitive device such as a touch screen.

Compensation for a capacitance change can be determined by the processor in subsystem 602, the host processor 628, dedicated logic such as a state machine, or any combination thereof according to various embodiments.

Note that one or more of the functions described above can be performed, for example, by firmware stored in memory (e.g., one of the peripherals) and executed by the processor subsystem 602, or stored in the program storage 632 and executed by the host processor 628. The firmware can also be stored and/or transported within any computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer readable storage medium” can be any medium that can contain or store the program for use by or in connection with the instruction execution system, apparatus, or device. The computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

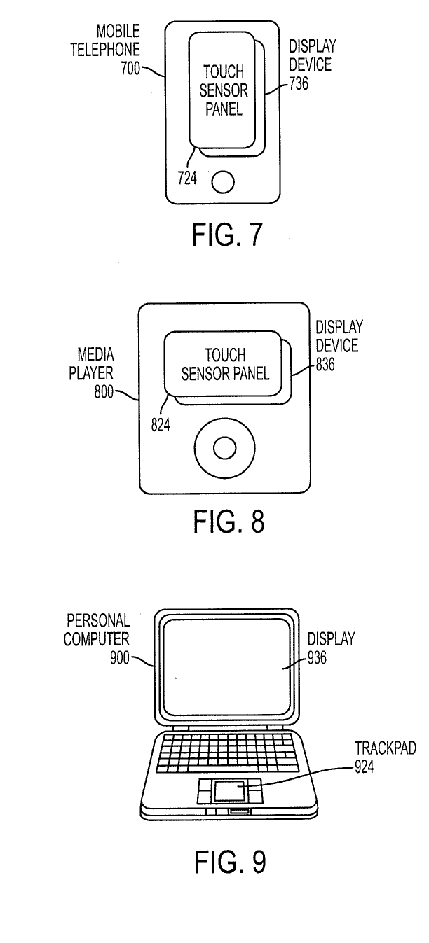

FIG. 7 illustrates an exemplary mobile telephone 700 that can include a display 736 and a touch sensor panel 724 that can compensate for capacitance changes according to various embodiments.

FIG. 8 illustrates an exemplary digital media player 800 that can include a display 836 and a touch sensor panel 824 that can compensate for capacitance changes according to various embodiments.

FIG. 9 illustrates an exemplary personal computer 900 that can include a touch sensitive display 936 and a touch sensor panel (trackpad) 924, where the touch sensitive display and the trackpad can compensate for capacitance changes according to various embodiments.

The mobile telephone, media player, and personal computer of FIGS. 7 through 9 can advantageously adapt to various operating conditions to provide more accurate touch sensing with a touch sensor panel that can compensate for capacitance changes according to various embodiments.

Although embodiments describe touch sensors, it is to be understood that proximity and other types of sensors can also be used. It is to be further understood that the touch sensing device according to various embodiments can be used to compensate hover measurements, combined touch and hover measurements, and the like for undesirable capacitance changes.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A touch sensing device comprising:
at least one capacitive sensor disposed on a first substrate for sensing a touch at the sensor;
a first conductive trace disposed on a second substrate and coupled to the sensor for transmitting a touch capacitance measurement indicative of the touch; and
a second conductive trace disposed on the second substrate, decoupled from the sensor, and proximate to the first conductive trace, the second conductive trace for transmitting a reference capacitance measurement indicative of a non-touch capacitance change so as to compensate for the non-touch capacitance change during transmission of the touch capacitance measurement, the non-touch capacitance change being associated with at least one of the first substrate or the second substrate.

2. The device of claim 1, further comprising at least a third conductive trace disposed on the second substrate, decoupled from the sensor, and proximate to the first conductive trace, the third conductive trace for transmitting another reference capacitance measurement indicative of the non-touch capacitance change so as to compensate for the non-touch capacitance change during transmission of the touch capacitance measurement.

3. The device of claim 1, wherein the second substrate comprises a flexible circuit having the first and second conductive traces disposed thereon, wherein the non-touch capacitance change is associated with the flexible circuit.

4. The device of claim 1, wherein the first substrate comprises a touch sensor panel having the sensor and portions of the first and second conductive traces disposed thereon, wherein the non-touch capacitance change is associated with the touch sensor panel.

5. The device of claim 1, wherein the first substrate comprises a touch sensor panel having the sensor, portions of the first and second conductive traces, and a conductive element disposed thereon,
the conductive element measures a non-touch capacitance change associated with the first substrate, and
the second conductive trace is coupled to the conductive element for transmitting a reference capacitance measurement from the conductive element so as to compensate for the non-touch capacitance change associated with the first substrate during transmission of the touch capacitance measurement,
wherein the non-touch capacitance change is associated with the touch sensor.

6. The device of claim 1, wherein the first substrate comprises a touch sensor panel having the sensor and portions of the first and second conductive traces disposed thereon, and
the second substrate comprises a flexible circuit having remaining portions of the first and second conductive traces disposed thereon,
wherein the non-touch capacitance change is associated with the touch sensor panel and the flexible circuit.

7. The device of claim 1, wherein the second conductive trace has a shorter length than the first conductive trace and is proximate to only a portion of the first conductive trace.

8. The device of claim 1 incorporated into at least one of a mobile telephone, a digital media player, or a personal computer.

9. A circuit comprising:
a first substrate having a sensor thereon, the first substrate being sensitive to a state change in the circuit;
a second substrate having at least two conductive traces thereon, the second substrate being sensitive to the state change in the circuit, a first of the conductive traces being associated with the sensor to transmit a signal from the sensor and a second of the conductive traces being disassociated from the sensor; and
logic for determining from the second of the conductive traces a capacitance effect of the state change at the second substrate and for reducing the determined capacitance effect in the transmitted signal.

10. The circuit of claim 9, wherein the state change in the circuit comprises at least one of a change in environmental conditions or a change in operation of the circuit.

11. The circuit of claim 9, wherein:
the second substrate has a third of the conductive traces that is disassociated from the sensor, and
the logic determines from the third of the conductive traces the capacitance effect of the state change at the second substrate and reduces the capacitance effect determined from the third of the conductive traces in the transmitted signal.

12. The circuit of claim 9, wherein:
the first substrate has a sensor trace thereon to couple the sensor to the first of the conductive traces and to transmit the signal from the sensor to the first of the conductive traces,
the second of the conductive traces on the second substrate extends to the first substrate to be proximate to the sensor trace, and
the logic determines from the second of the conductive traces the capacitance effect of the state change at the first and second substrates and reduces the determined capacitance effect in the transmitted signal.

13. The circuit of claim 9, wherein:
the first substrate has a conductive element and a sensor trace thereon, the sensor trace coupling the sensor to the first of the conductive traces and transmitting the signal from the sensor to the first of the conductive traces,
the second of the conductive traces on the second substrate extends to the first substrate to couple to the conductive element and to be proximate to the sensor trace, and
the logic determines from the second of the conductive traces the capacitance effect of the state change at the first and second substrates and reduces the determined capacitance effect in the transmitted signal.

14. The circuit of claim 9, wherein the first substrate is glass.

15. The circuit of claim 9, wherein the second substrate is a flexible polymer.

16. The circuit of claim 9, wherein the capacitance effect is associated with a change in a dielectric constant of at least one of the first or second substrate.

17. The circuit of claim 9, wherein the first and second substrates can have different sensitivities to the state change.

18. A method comprising:
measuring a touch at a touch sensing device, the touch measurement comprising a first capacitance of a touch region of the device, the first capacitance indicative of a touch at the device, and a second capacitance of a transmitting region of the device coupled to the touch region, the second capacitance indicative of an environmental change at the device;
measuring the second capacitance in the transmitting region using a reference conductive trace decoupled from the touch region; and
adjusting the touch measurement based on the second capacitance measurement to compensate the touch measurement for the environmental change at the device.

19. The method of claim 18, wherein the first capacitance is also indicative of the environmental change at the device, and wherein adjusting the touch measurement comprises:
calculating a change in capacitance in the touch region based the touch measurement and a capacitance in the touch region prior to the environmental change;
calculating a change in capacitance in the transmitting region based on the second capacitance measurement and a capacitance in the transmitting region prior to the environmental change; and
subtracting the calculated changes in the tough region and the transmitting region from the touch measurement to compensate the touch measurement for the environmental change at the device.

20. The method of claim 18, wherein adjusting the touch measurement comprises:
determining a ratio between the second capacitance measurement and a capacitance in the transmitting region prior to the environmental change; and
applying the determined ratio to a capacitance in the touch region prior to the environmental change to compensate the touch measurement for the environmental change at the device.

21. The method of claim 18, wherein the environmental change includes at least one of a temperature change, a humidity change, or a pressure change.

22. A touch sensing device comprising:
multiple touch sensors disposed on a substrate to sense a touch at the device;
a flexible circuit coupled to the touch sensors to transmit touch signals from the touch sensors indicative of the sensed touch, the flexible circuit including a first conductive trace to transmit the touch signals and a second conductive trace to measure an effect of an environmental change on the device; and
a sensing circuit coupled to the flexible circuit to process the transmitted touch signals, including compensating the transmitted touch signals for the measured effect of the environmental change,
wherein at least one of the substrate, the flexible circuit, or the sensing circuit is sensitive to the environmental change.

23. The device of claim 22, wherein the sensors are self capacitance sensors.

24. The device of claim 22, wherein the sensors are mutual capacitance sensors.

25. A method comprising:
measuring a first capacitance change associated with a touch at a touch sensing device using a first conductive trace coupled to a touch sensor of the device;
measuring a second capacitance change at the touch sensing device using a second conductive trace positioned parallel to the first conductive trace and decoupled from the touch sensor, the second capacitance change not associated with the touch and associated with an operating change of the device; and
adjusting the first capacitance measurement based on the second capacitance measurement to compensate for the second capacitance change.
